(19) United States
(12) Patent Application Publication
(10) Pub. No.: US 2011/0179315 A1
(43) Pub. Date: Jul. 21, 2011

(54) SERDES LINK ERROR MANAGEMENT

(75) Inventor: Frank S. Yang, Cupertino, CA (US)

(73) Assignee: BROCADE COMMUNICATIONS SYSTEMS, INC., San Jose, CA (US)

(21) Appl. No.: 13/010,760

(22) Filed: Jan. 20, 2011

Related U.S. Application Data
(60) Provisional application No. 61/297,273, filed on Jan. 21, 2010.

(51) Int. Cl. G06F 11/00

(52) U.S. Cl. 714/48; 714/E11.004

(57) ABSTRACT

Techniques for dynamically measuring and monitoring error rate in Serializer/Deserializer (SerDes) links In one set of embodiments, a method includes polling a SerDes link status of a SerDes link at a predetermined rate. The method also includes storing a predetermined polling results in a memory, determining a number of polling results indicating one or more errors occurred in said SerDes link, determining an action to be taken if said number of polling results exceed a threshold.

### CROSS-REFERENCES TO RELATED APPLICATIONS

The present application is a non-provisional of and claims the benefit and priority under 35 U.S.C. 119(e) of U.S. Provisional Application No. 61/297,273, filed Jan. 21, 2010 and entitled “SERDES LINK ERROR MANAGEMENT,” the entire contents of which are incorporated herein by reference for all purposes.

### BACKGROUND

The present application relates to error management in data communication, and a techniques for more dynamically measuring error rate in such devices.

A Serializer/Deserializer (SerDes) is an integrated circuit (IC or chip) transceiver circuit (hereinafter “SerDes”) that converts data between a serial data form and a parallel data form. A SerDes link is an electrical connection or path between a SerDes device located in one integrated circuit chip and a SerDes device located in another integrated circuit chip. A typical application for a SerDes link is within a data communication device, such as a network switch, or mobile telephone/PDA device. Errors that occur in a SerDes link of, for instance, a network device, could cause dropped or corrupted data packets or cells (hereinafter generically “packets”). The higher the error rate in a SerDes link, the more likely packet dropping or corrupting will occur. Accordingly, techniques are desirable for dynamically monitoring and measuring error rates of a SerDes link.

### BRIEF SUMMARY

Embodiments of the present invention provide techniques for dynamically measuring and monitoring error rate in one or more SerDes links within a device. In one set of embodiments, a method includes polling a SerDes link status at a predetermined rate. The exemplary method also includes storing a predetermined polling results in a memory, determining a number of polling results indicating one or more errors occurred in the SerDes link, determining an action to be taken if the number of polling results exceed a threshold. Actions may include, for instance, making automatic adjustments in the operation of the device, and/or providing an alert or other report to a user of the device.

In one embodiment, a method of polling a link status includes polling the link status from a hardware device, such as integrated circuit chips.

According to another set of embodiments, an apparatus includes a first integrated circuit and a second integrated circuit which have their output terminals connected through a SerDes link. The integrated circuits have SerDes link status outputs capable of indicating whether one or more errors occurred in the SerDes link The apparatus further includes instructions stored in a memory that cause a processor to poll a SerDes link status at a predetermined rate, store a predetermined number of polling results in a memory, determine a number of polling results indicating one or more errors occurred in the SerDes link, and determine an action to be taken if the number of polling results exceed a threshold.

The foregoing, together with other features, aspects, and advantages of the embodiments of present invention, will become more apparent when referring to the following description, and accompanying drawings.

### BRIEF DESCRIPTION OF THE DRAWINGS

FIG. 1 is a simplified block diagram illustrating a network device that may incorporate an embodiment of the present invention.

FIG. 2 is a flowchart illustrating steps performed in a network device for dynamically measuring and monitoring error rate in SerDes links in accordance with an embodiment of the present invention.

### DETAILED DESCRIPTION

In the following description, for the purposes of explanation, specific details are set forth in order to provide a thorough understanding of various embodiments. It will be apparent, however, that the invention may be practiced without these specific details.

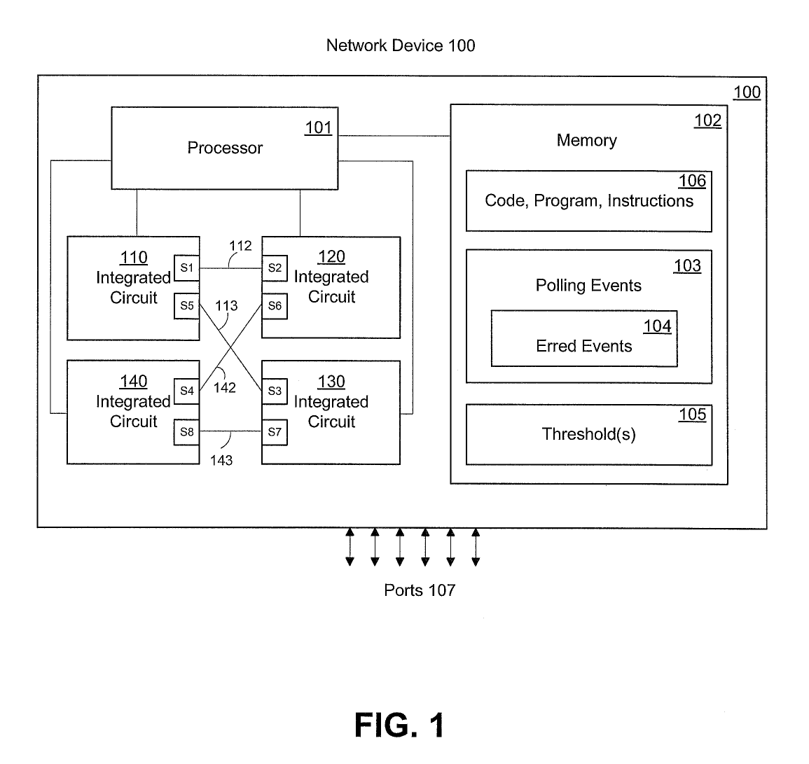

FIG. 1 is a simplified diagram of a network device 100 that may incorporate an embodiment of the present invention. Network device 100 may be any device that is capable of receiving and forwarding data via ports 107. Examples of network device 100 include a switch, a router, telephone/PDA or any device is capable of forwarding or receiving data. Practitioners will appreciate that other computing devices that internally communicate data using one or more SerDes links, such as workstations, personal computers, and other computing device, may be substituted for network device 100.

As shown in FIG. 1, network device 100 comprises a plurality of integrated circuit chips 110, 120, 130, and 140, a plurality of SerDes links 112, 113, 142, and 143 electrically connecting the integrated circuits chips 110, 120, 130, and 140, a processor 101 coupled to the integrated circuits chips 110, 120, 130, and 140, and a memory 102 coupled to processor 101. Although four integrated circuit chips and four SerDes links are depicted, practitioners will appreciate that network device 100 may support any number of integrated circuit chips and SerDes links. Integrated circuit chips 110, 120, 130, and 140 may be, for instance, processors, application-specific integrated circuit (ASIC) devices, or field-programmable gate array (FPGA) devices. For instance, integrated circuit chips 110, 120, and 130 may be Fabric Access Processors (FAP), and integrated circuit chip 140 may be Fabric Element devices (FE200) provided by Broadcom Corporation. In an alternative embodiment, network device 100 may contain a plurality of processors 101, which may be PowerPC microprocessors.

Integrated circuits chips 110, 120, 130, and 140 depicted in FIG. 1 may be configured to perform various functions, associated with the receiving and forwarding of data packets by network device 100, such as packet forwarding, packet switching, memory look up, network traffic management, and the like. Integrated circuits chips 110, 120, 130, and 140 may all be the same kind of integrated circuits, or may be a mix of a plurality of different kinds of integrated circuits.

Memory 102 may contain software 106 (e.g., instructions, code, program) executed by processor 101, and data, such as polling events 103 and erred events 104. Memory 102 may also store configuration information, such as threshold(s) 105, defined by a user of the network device (e.g. a network administrator) through various tools, including command-line interfaces (CLIs), graphical user interfaces (GUIs), and the like. In one embodiment, software 106, when executed by processor 101, cause processor 101 to monitor and measure error rates of SerDes links 112, 113, 142, and 143 within network device 100. In an alternative embodiment, network device 100 may contain a plurality of memories 102. Examples of memory 102 include a flash memory, a RAM, or a content addressable memory (CAM).

A SerDes link is a connection or path between a SerDes device located in one integrated circuit chip and a SerDes device located in another integrated circuit chip. For instance, in the example shown in FIG. 1, four SerDes links are formed as follow:

(1) SerDes link 112 connected between SerDes device S1 of integrated circuit chip 110 and SerDes device S2 of integrated circuit chip 120
(2) SerDes link 113 connected between SerDes device S5 of integrated circuit chip 110 and SerDes device S3 of integrated circuit chip 130
(3) SerDes link 142 connected between SerDes device S4 of integrated circuit chip 140 and SerDes device S6 of integrated circuit chip 120
(4) SerDes link 143 connected between SerDes device S8 of integrated circuit chip 140 and SerDes device S7 of integrated circuit chip 130
Each integrated circuit chips 110, 120, 130, and 140 depicted in FIG. 1 may have one or more SerDes devices to form one or more SerDes links with other integrated circuit chips in network device 100.

In one embodiment, network device 100 is configured to monitor and measure error rates of some or all of SerDes links 112, 113, 142, and 143 between integrated circuit chips 110, 120, 130, and 140. For instance, network device 100 may be configured to poll integrated circuits chips 110, 120, 130, and 140 for link statuses of SerDes links 112, 113, 142, and 143 a predetermined rate. Polling link statuses of SerDes links 112, 113, 142, and 143 from integrated circuits chips 110, 120, 130, and 140, called polling event 103 herein, is executed by processor 101. A result of polling event 103 is generated according to information of status bit registers located in integrated circuits chips 110, 120, 130, and 140. The result of polling event 103, without limitation, may include one or more erred SerDes link ID numbers, one or more SerDes device error types (e.g. CRC error, disparity error), and one or more SerDes device ID numbers. The results of polling event 103 are time stamped and stored in memory 102 by processor 101. In one embodiment, if one or more errors occur within a SerDes link in one polling event, that polling event is an erred polling event 104. Processor 101 may be configured to store a predetermined number of polling events 103 and erred polling events 104 in memory 102. Memory 102 may also contain software 106 (e.g. code, program, instructions) that, when executed by processor 101, cause processor 101 to polling link statuses of SerDes links 112, 113, 142, and 143 from integrated circuits chips 110, 120, 130, and 140, and store the results in memory 102.

In one embodiment, a 1-bit latch status circuit may be used to indicate at least one error occurred within a SerDes link between two polling events. The 1-bit latch status circuit is asserted when one error occurs within a SerDes link. The 1-bit latch status circuit will keep asserted until a processor clears the asserted status circuit after a polling event.

Network device 100 may initiate one or more actions when a number of erred polling events 103 exceed a stored threshold 105. In one embodiment, only a predetermined number of past polling events is considered when determining one or more actions to take. In one embodiment, if a threshold is approached, met, exceeded, network device 100 may initiate remedial actions, such as to avoid or limit the number or effect of the SerDes errors. For instance, one of the actions initiated by network device 100 is to shut down the SerDes device or SerDes link associated with the excessive erred polling events through, e.g., a register write operation. In another embodiment, one of the actions initiated by network device 100 is to stop polling the SerDes device or SerDes link which has been shut down.

In one embodiment, one of the actions initiated by network device 100 is to shut down one or more corresponding SerDes devices that connect to a SerDes device that is associated with excessive erred polling events through one or more SerDes links. For instance, SerDes device S1 of integrated circuit 110 may be determined as the SerDes device being shut down due to excessive erred polling events. Network device 100 may then initiate an action of shutting down its corresponding SerDes device S2 of integrated circuit 120, so SerDes device S2 won't transmit data to erred SerDes device S1 through SerDes link 112.

In another embodiment, one of the actions initiated by network device 100 is to notify one or more corresponding SerDes devices that connect to a SerDes link associated with excessive erred polling events. For instance, SerDes link 112 may be determined as the SerDes link being shut down due to excessive erred polling events from polling integrated circuit 110. Network device 100 may then initiate an action of notifying SerDes device S2 of integrated circuit 120 to shut down SerDes link 112, so SerDes device S2 won't transmit data through SerDes link 112.

Another type of action that may be taken is a reporting action. For instance, processor 101 may generate an alert message that may be displayed on a screen to a user, which notifies of an error condition.

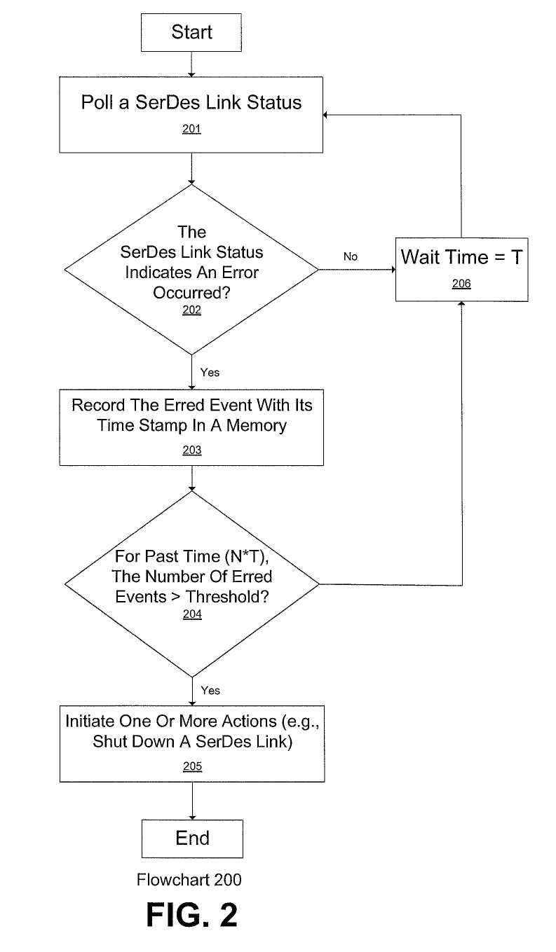

FIG. 2 depicts a simplified flowchart 200 depicting an exemplary method performed by a network device 100 providing SerDes error management technique, according to an embodiment of the present invention. The processing depicted in flowchart 200 may be performed by a processor 101 executing software 106 (e.g. instructions, code, program), in hardware, or in combinations thereof. The processing in FIG. 2 may be manually initiated or defined by a user of the network device (e.g. a network administrator), or may be programmed to be performed periodically.

The polling operation 201 obtains a SerDes link status from integrated circuit chip 110, 120, 130 and 140 every T seconds, where T is selected by a network administrator through either command-line interfaces (CLIs) or graphical user interfaces (GUIs) and stored in memory 102.

An erred SerDes link determining operation 202 determines whether any error occurs from the polling operation 201. If so, processing proceeds to an error event recording operation 203. Otherwise, processing proceeds to next polling event 201 after waiting for T seconds 206.

The error recording event 203 may stores a time stamp information, an erred SerDes link number, and the identity of the affected one or more SerDes devices connected through the erred SerDes link in memory 102.

The SerDes link failure decision operation 204 determines that for the past N polling events, whether a number of erred polling events are greater than a threshold. If so, a SerDes link failure is confirmed and processing proceeds to initiate one or more actions 205. Otherwise, processing proceeds to next polling event 201 after waiting for T seconds 206. In one embodiment, the threshold and N may be defined by a network administrator through either command-line interfaces (CLIs) or graphical user interfaces (GUIs).

The depicted process initiates one or more actions 205 regarding an erred SerDes link when its respective number of corresponding erred events are greater than a threshold. In one embodiment, one of actions may be shut down the erred SerDes link to prevent it being used for data transmission. In another embodiment, the action 205 may include providing an alert or error report to a user.

SerDes error management provides flexibility in determining a SerDes link failure within a network device 100. By dynamically monitoring and measuring error rate occurred in a SerDes device based on software or user configuration, network users can shut down any SerDes link in a network device based on a user-defined SerDes link error policy, thereby ensuring the reliability of network device 100.

While the present invention has been described with respect to a limited number of embodiments, practitioners will appreciate numerous modifications and variations therefrom. For instance, while the various embodiments described above have been described in the context of network devices, the teaching herein may be applied in different domain other than networking, such as general purpose computing. It is intended the appended claims cover all such modification and variations as fall within the true spirit and scope of this present invention.

What is claimed is:

1. A method comprising:
polling a serdes link status of a serdes link at a predetermined rate;
storing a predetermined number of polling results in a memory;
determining a number of polling results indicating one or more errors occurred in said serdes link; and
determining an action to be taken if said number of polling results exceed a threshold.

2. A method of claim 1, wherein polling a link status comprises:
polling said serdes link status from an integrated circuit coupled to said serdes link

3. A method of claim 1, wherein said action further comprising shutting down said serdes link.

4. An apparatus comprising:
a memory configured to store software and a predetermined number of polling results;
a serdes link; and
a processor coupled to said memory, and operable to execute said software, wherein said processor is operable to poll a serdes link status of said serdes link at a predetermined rate, store a predetermined number of polling results in a memory, determine a number of polling results indicating one or more errors occurred in said serdes link, and determine an action to be taken if said number of polling results exceed a threshold.

5. An apparatus of claim 4, wherein poll a serdes link status comprises:
polling said serdes link status from an integrated circuit that is coupled to said serdes link.

6. An apparatus of claim 4, wherein said action further comprising shutting down said serdes link

7. An apparatus comprising:
a serdes link coupled between a first integrated circuit and a second integrated circuit, wherein at least one of said first and said second integrated circuits has a serdes link status output capable of indicating whether one or more errors occurred in said serdes link;
a processor;
a memory including instructions that, when executed by said processor, cause said processor to poll a serdes link status of a serdes link at a predetermined rate, store a predetermined polling results in a memory, determine a number of polling results indicating one or more errors occurred in said serdes link, and determine an action to be taken if said number of polling results exceed a threshold.

8. An apparatus of claim 7, wherein said first integrated circuit and second integrated circuit are elements within a network device.
